(19) United States
(12) Patent Application Publication
(10) Pub. No.: US 2015/0114571 A1
(43) Pub. Date: Apr. 30, 2015

(54) UNI-STAGE TIRE BUILDING DRUM

(71) Applicant: The Goodyear Tire & Rubber Company, Akron, OH (US)

(72) Inventors: Douglas Raymond Weaver, Uniontown, OH (US); Jeffrey Joseph Kavali, Ravenna, OH (US)

(73) Assignee: The Goodyear Tire & Rubber Company, Akron, OH (US)

(21) Appl. No.: 14/065,868

(22) Filed: Oct. 29, 2013

(51) Int. Cl. B29D 30/24

(52) U.S. Cl. CPC B29D 30/244; B29D 2030/2664
USPC 156/415

(57) ABSTRACT

A tire building drum is described which includes a rotatable drum having a center section and a right and left section, wherein the right and left section are each located adjacent the center section, wherein the right and left sections each have a radially expandable bead lock mechanism mounted on a sliding cylinder, wherein the bead lock mechanisms are axially movable independent of each other, wherein the ends of the center section are each connected to a plurality of radially expandable lifter housings, wherein each lifter housing is connected to a linkage system, wherein each sliding cylinder has a front face positioned for engagement with the linkage system, wherein actuation of the sliding cylinder causes the lifter system to radially expand and the radial expansion of the center section.

### FIELD OF THE INVENTION

The invention relates to tire building, and more particularly to a tire building drum.

### BACKGROUND OF THE INVENTION

The manufacture of tires typically involves a tire building drum wherein numerous tire components are applied to the drum in sequence, forming a cylindrical shaped tire carcass. This stage of the tire building process is commonly referred to as the “first stage” of the tire building process. The tire carcass is then typically removed from the tire building drum and sent to a second stage, expandable tire shaping drum where the carcass is expanded into a toroidal shape for receipt of the remaining components of the tire such as the belt package and a rubber tread. The completed toroidally shape unvulcanized tire carcass or green tire is then removed from the second stage drum and subsequently molded and vulcanized into a finished tire.

The prior art process thus requires two tire building drums and the transfer of the carcass from one drum to the other. Further, a problem often arises in precisely locating and anchoring the tire beads on the unvulcanized tire carcass, especially during the transportation of the tire beads from the first stage drum to the second stage drum. Variations in bead positioning can result in ply distortion in the tire.

Tire manufacturers have recently begun moving towards the utilization of a single tire building drum, for both the first and second stage tire building. This requires that the tire building drum be capable of axial expansion and contraction as well as radial expansion/contraction. Further, it is important to maintain a positive bead lock during the entire tire building process, including the tire shaping, so that the ply cord length is maintained, resulting in good tire uniformity. Due to the fact that the tire building drum axially and radially expands, it is important that both sides of the tire building drum move in synchronization. If one side of the drum is out of synchronization with the other side of the drum, problems in tire uniformity can occur. It is additionally desired to support the apex and bead assembly in a vertical manner while avoiding unwanted displacements of the tire components, particularly the ply.

### SUMMARY OF THE INVENTION

The invention provides in a first aspect a tire building drum including a rotatable drum. The rotatable drum has a center section, left section and right section, wherein the right and left sections are movable in the axial direction. The center section is radially expandable, and the center section further includes a first half and a second half, wherein the first half and the second half are axially movable with respect to each other so that the center section has an adjustable width. The right and left sections have a radially expandable bead lock mechanism, wherein the bead lock mechanisms are axially movable independent of each other.

The invention provides in a second aspect a tire building drum including a rotatable drum having a center section and a right and left section, wherein the right and left section are each located adjacent the center section, wherein the right and left sections each have a radially expandable bead lock mechanism mounted on a sliding cylinder, wherein the bead lock mechanisms are axially movable independent of each other, wherein the ends of the center section are each connected to a plurality of radially expandable lifter housings, wherein each lifter housing is connected to a linkage system, wherein the sliding cylinder has a front face positioned for engagement with the linkage system causing the lifter system to radially expand and the radial expansion of the center section.

### Definitions

For ease of understanding this disclosure, the following items are defined:

“Apex” means an elastomeric filler located radially above the bead and interposed between the plies and the ply turn-up.

“Axial” and “axially” means the lines or directions that are parallel or aligned with the longitudinal axis of rotation of the tire building drum.

“Bead” means that part of the tire comprising an annular tensile member commonly referred to as a “bead core” wrapped by ply cords and shaped, with or without other reinforcement elements such as flippers, chippers, apexes, toe guards and chafers, to fit the design rim.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Carcass” means an unvulcanized laminate of tire ply material and other tire components cut to length suitable for splicing, or already spliced, into a cylindrical or toroidal shape. Additional components may be added to the carcass prior to its being vulcanized to create the molded tire.

“Casing” means the tire carcass and associated tire components excluding the tread.

“Chafers” refers to narrow strips of material placed around the outside of the bead to protect cord plies from the rim, distribute flexing above the rim, and to seal the tire.

“Circumferential” means lines or directions extending along the perimeter of the surface of the annular tread perpendicular to the axial direction.

“Cord” means one of the reinforcement strands of which the plies in the tire are comprised.

“Equatorial Plane (EP)” means the plane perpendicular to the tire's axis of rotation and passing through the center of its tread.

“Innerliner” means the layer or layers of elastomer or other material that form the inside surface of a tubeless tire and that contain the inflating fluid within the tire.

“Insert” means an elastomeric member used as a stiffening member usually located in the sidewall region of the tire.

“Ply” means a continuous layer of rubber-coated parallel cords.

“Radial” and “radially” mean directions radially toward or away from the axis of rotation of the tire building drum.

“Radial Ply Tire” means a belted or circumferentially restricted pneumatic tire in which at least one layer of ply has the ply cords extend from bead to bead at cord angles between 65° and 90° with respect to the equatorial plane of the tire.

“Shoulder” means the upper portion of sidewall just below the tread edge.

“Sidewall” means that portion of a tire between the tread and the bead.

“Tread” means a rubber component which when bonded to a tire carcass includes that portion of the tire that come into contact with the road when the tire is normally inflated and under normal load.

“Tread Width” means the arc length of the tread surface in the axial direction, that is, in a plane parallel to the axis of rotation of the tire.

### BRIEF DESCRIPTION OF THE DRAWINGS

The invention will be described by way of example and with reference to the accompanying drawings in which:

FIG. 1 is a cross-sectional side view of a tire building drum shown in the start position;

FIG. 2 is a perspective view of the hub subassembly of the tire building drum of FIG. 1, shown with the center section removed;

FIG. 3 is an exploded view of one half of the hub subassembly of the tire building drum;

FIG. 4 is cross-sectional view of one half of the hub sub assembly of FIG. 3;

FIG. 5A is a front view of the hub subassembly of FIG. 3 shown in the contracted position;

FIG. 5B is a cross-sectional view of the hub subassembly in the direction 5b-5b of FIG. 2;

FIG. 6A is a front view of the hub subassembly of FIG. 3 shown in the expanded position;

FIG. 6B is a cross-sectional view of the hub subassembly of FIG. 5B shown in the actuated position;

### DETAILED DESCRIPTION OF THE INVENTION

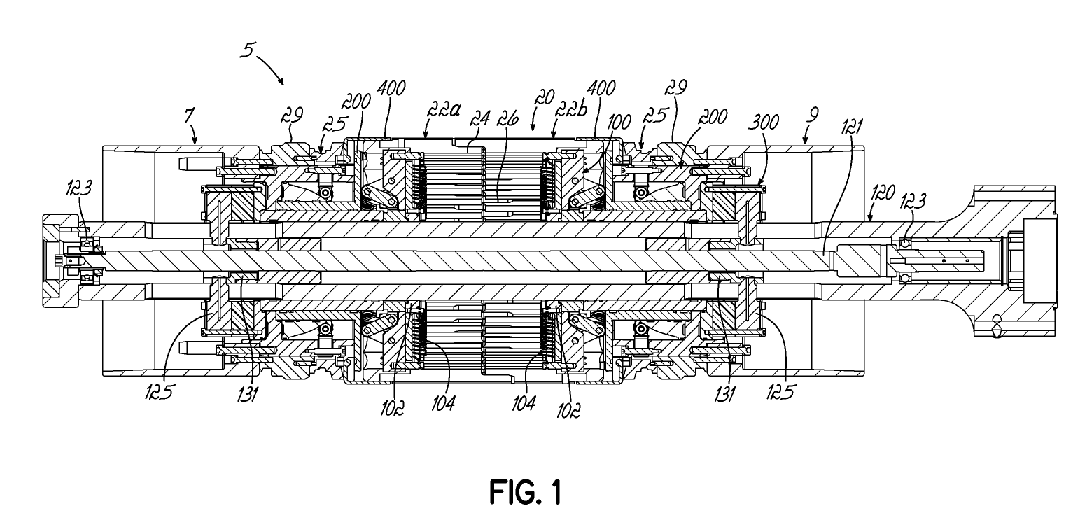

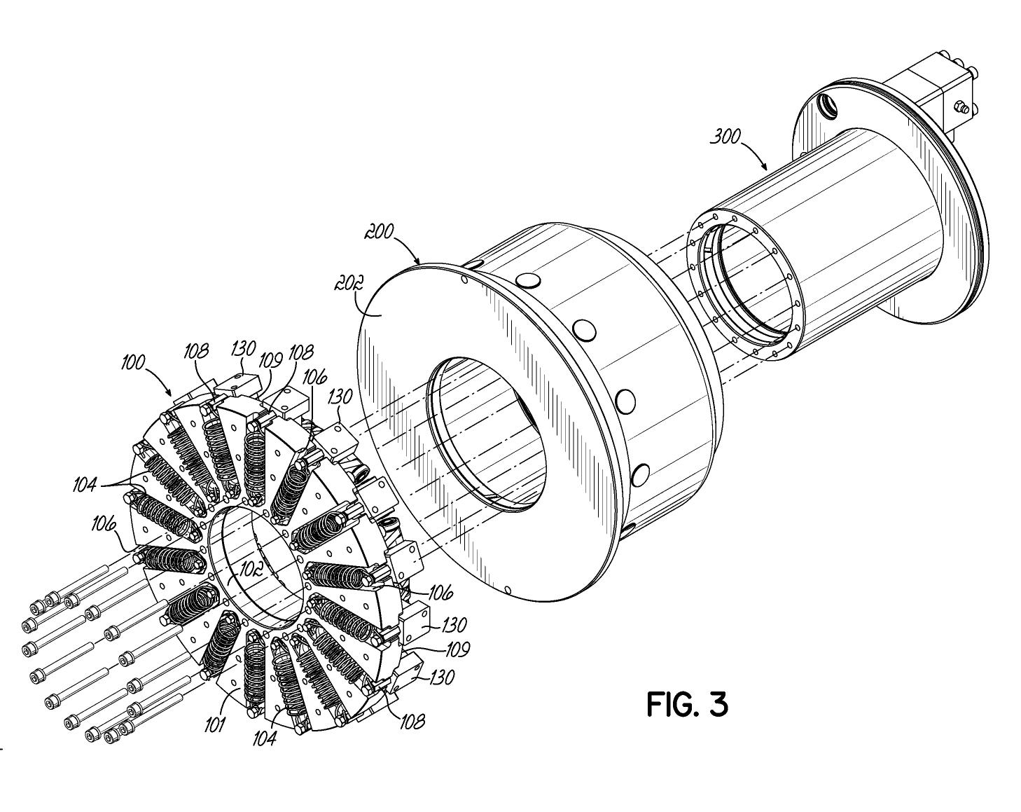

With reference to FIGS. 1 through 6, an exemplary tire building drum 5 of the present invention is illustrated. As shown more particularly in FIG. 1, the tire building drum 5 has a left hand side 7 and a right hand side 9 joined together by a center section 20. Adjacent the center section 20 are first and second bead locking mechanisms 25, which are also radially movable. Adjacent the bead locking mechanisms are first and second shoulder segments 29. Both the bead locking mechanisms 25 and the shoulder segments 29 are axially movable. Thus, both the left hand side and the right hand side of the drum are axially movable. These components are described in more detail, below.

### Center Section

The center section 20 of the tire building drum further comprises a plurality of center segments 22 located about the outer circumference of the drum. Each of the center segments are split into a left hand side 22a and a right hand side 22b, as shown in FIG. 1. Each side 22a, 22b has one or more finger-like projections 24 which are axially slidable into one or more opposed recesses 26 in an interdigitated or interlocked manner, so that the center section may axially expand or contract.

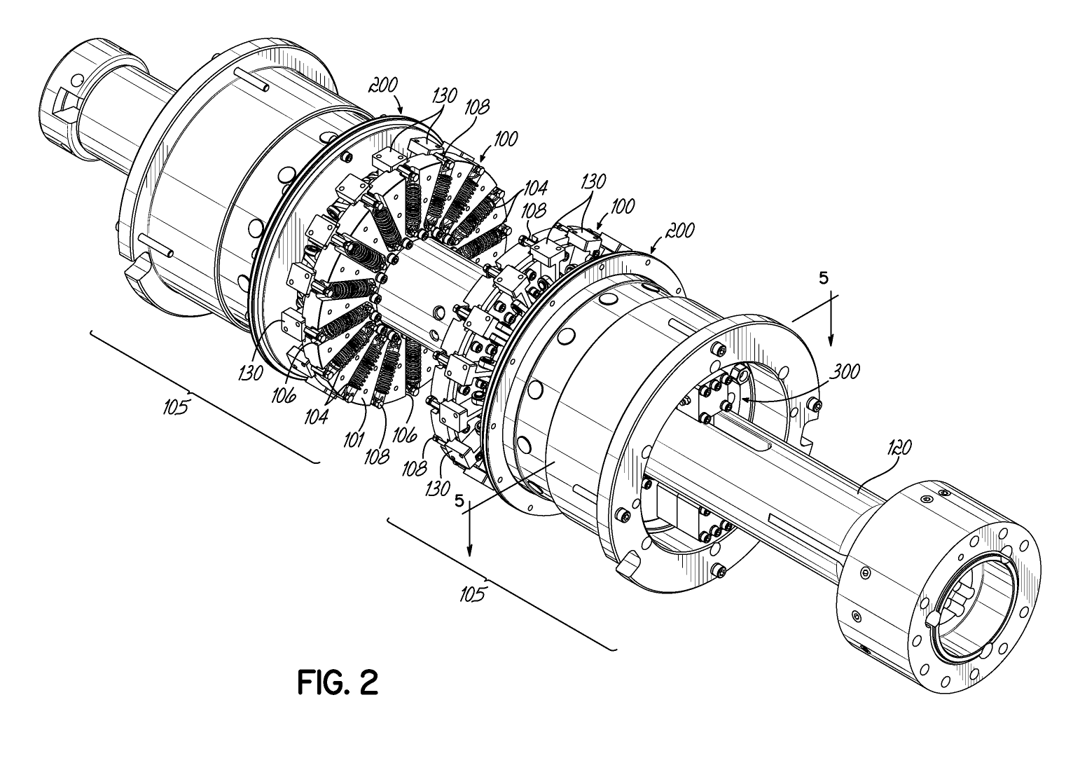

The right hand side 22b and the left hand side 22a of the center section are also radially expandable or contractable. The center section 20 may radially expand in the range of about 20 to about 50 mm. As each center segment 22 radially expands, the gap between center segments increases. Each center segment half 22a,b has an axially outer end that is connected to an expansion deck 100. FIG. 2 illustrates the hub subassemblies 105 for each drum half, wherein each hub subassembly includes an expansion deck 100. The expansion deck 100 radially expands and contracts the center section segments. The expansion deck has an inner hub 102 that is mounted on the central drive shaft 120. As shown in FIG. 2, each expansion deck 100 has a plurality of radially mounted springs 104 on a first side 101. Each spring is mounted in a slot 106. A first end 103 of the spring is pinned to a pin 107 located in the lower end of the slot 106. A second end 105 of the spring 104 is mounted to a radially outward pin 108. Pin 108 is connected to a lifter housing 130 located on the second side 109 of the expansion deck 100, opposite the first side 101. A lifter housing 130 is associated with each spring 104. Each spring 104 biases a respective lifter housing 130 into its radially inward position. Both the right hand side and the left hand side of the center section is connected to an expansion deck, so that each lifter housing functions to radially expand the center section in unison.

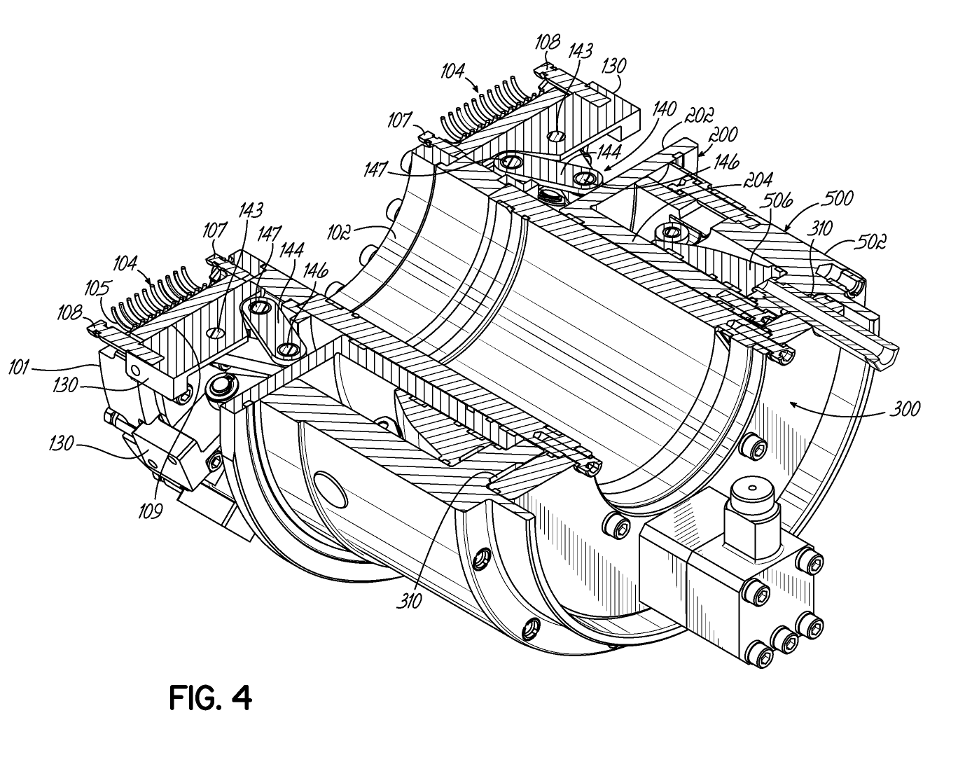

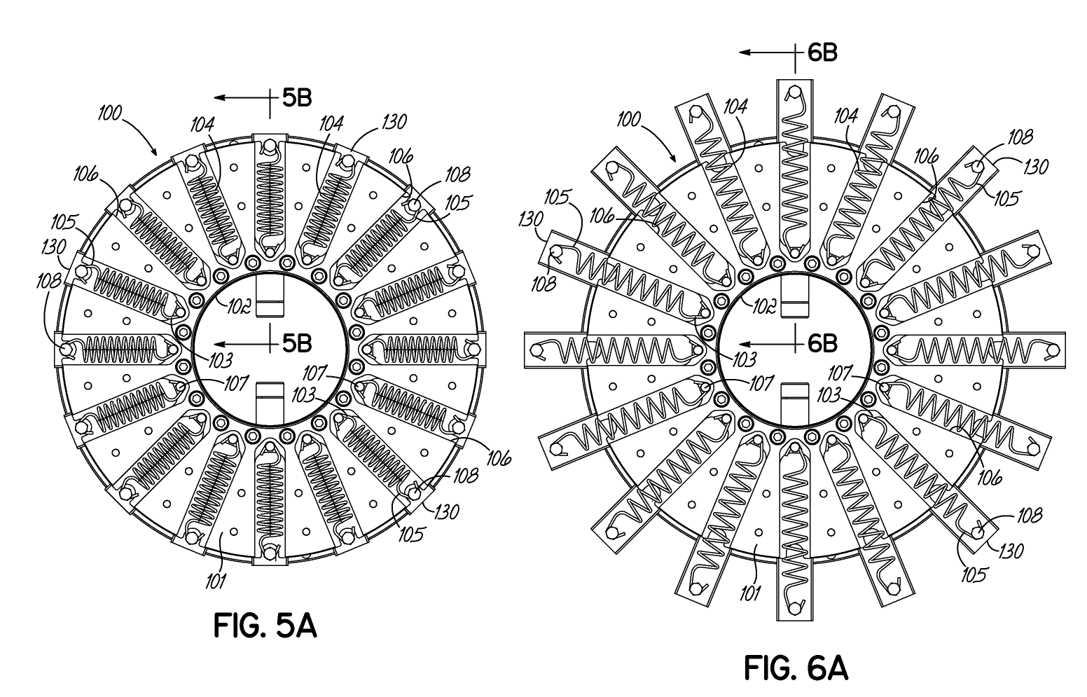

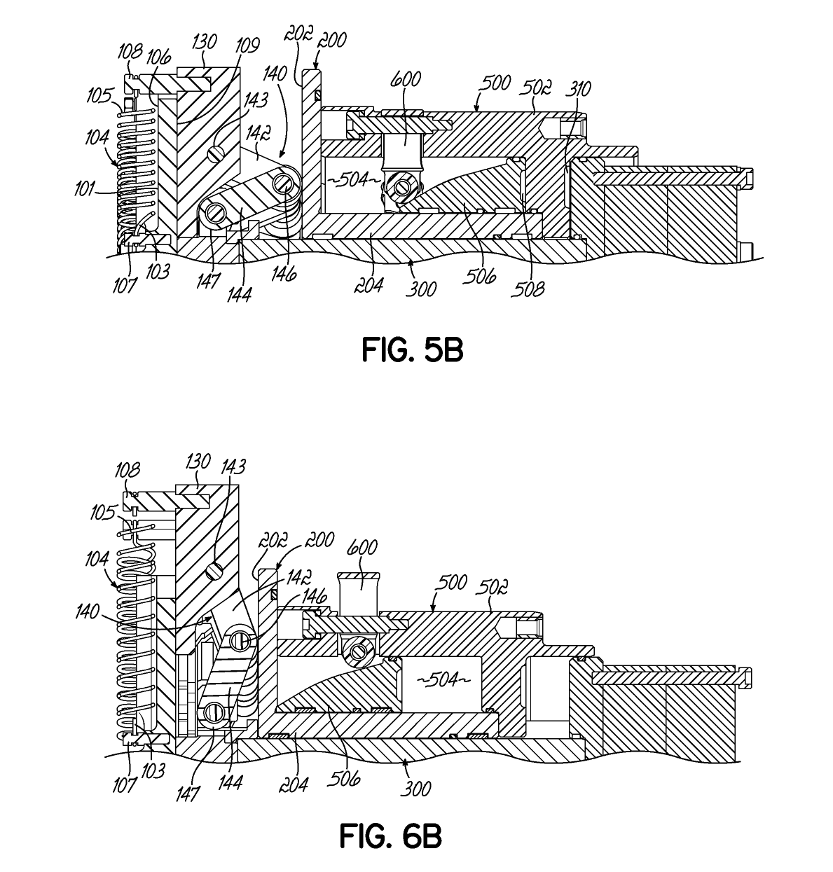

As shown in FIG. 4, each lifter housing 130 is actuated by a linkage system 140. FIG. 5b illustrates the lifter housing 130 and the linkage system 140 in the collapsed position. The linkage system has a first link 142 having a first pinned end 143 connected to the lifter housing 130. The first link is connected to a second link 144 by a pinned connection 146. The radially inner end 147 of the second link 144 is pinned to the inner hub 102 of the expansion deck 100. The linkage system 140 is actuated by a sliding cylinder 200. The sliding cylinder 200 has a front face 202 that engages the linkage system 140. The sliding cylinder 200 has an outer sleeve 204 that slides on the inner drum sleeve 300. The sliding cylinder 200 is pneumatically actuated by gas or air fed to pocket 310, causing the outer sleeve 204 to slide over the inner drum sleeve 300. There are two sliding cylinders 200, one on the left and right hand side. Actuation of both sliding cylinders at the same time ensures that the right hand side and left hand side of the center section radially expands at the same time. When the sliding cylinder 200 is actuated, the outer sleeve 204 slides axially inward so that the front face 202 of the sliding cylinder engages the linkage system 140. The second link 144 is caused to be rotated about its pinned end 147, resulting in the radial extension of the first and second link 142, 144 in the radial direction. The lifter housing 130 extends radially outward, overcoming the force of spring 104. The radial expansion of each lifter housing 130 as shown in FIG. 6b results in the crowning of the center section 20 as shown in FIG. 6A.

As shown in FIG. 1, the outer exterior surface of the center section is not covered by a center sleeve. The outer axial ends of the center section are covered by a shoulder seal 400.

### Bead Lock Mechanism

Adjacent the center section 20 are first and second annular bead locking mechanisms 25. FIG. 1 illustrates the bead locking mechanisms 25 in the retracted position. FIG. 5B illustrates the bead lock actuation system 500. The bead lock actuation system 500 is mounted over the sliding sleeve 300. An annular bead lock housing 502 encloses the sliding sleeve 200 forming an annular piston chamber 504. A slidable piston 506 is received in the chamber. The slidable piston 506 is actuated by air or gas inserted into recess 508. FIG. 6B illustrates the slidable piston in the actuated position, which forces a roller 600 to roll up the surface of the position into the actuated position. The roller 600 is connected to the bead locking mechanisms 25, so that actuation of the roller 600 results in the radially expansion of the bead locking mechanisms 25.

### Drum Axial Expansion and Contraction

The entire left and right hand sections 7, 9 of the tire building drum are axially slidable. The axial sliding of each drum half is actuated by drive pins 125 mounted on nuts 131, which ride along drive screw 121. When the central screw is rotated, the nuts 131 move axially inward/outward, causing the drive pins 125 and each drum section to move axially inward/outward in corresponding fashion. In addition, the drive pins are also in mechanical cooperation with the split center segments, causing the split center segments 22a,b to axially extend or contract.

### Drive Shaft

A central drive shaft 120 is provided for rotational movement of the tire building drum 5 about its longitudinal axis. The central shaft 120 is connected to a drive means (not shown). Provided within the central drive shaft 120 is a central screw 121. The central screw 121 is supported at each end by bearings 123. The threads on one side of the central screw 121 are left handed and on the opposite side are right handed. On the left hand side is an inboard nut 131 connected to the one end of the threaded screw 121 and similarly on the opposite right hand side is an outboard ball nut 131 connected to the central screw 121.

While certain representative embodiments and details have been shown for the purpose of illustrating the invention, it will be apparent to those skilled in this art that various changes and modifications may be made therein without departing from the spirit or scope of the invention.

What is claimed is:

1. A tire building drum comprising: a rotatable drum having a center section and a left section located on the left side of the center section and a right section located on the right side of the center section, wherein the right and left sections are movable in the axial direction; said center section being radially expandable, said center section further comprising a first half and a second half, wherein the first half and the second half are axially movable with respect to each other so that the center section has an adjustable width, wherein the right and left sections have a radially expandable bead lock mechanism, wherein the bead lock mechanisms are axially movable independent of each other.

2. The tire building drum of claim 1 wherein the first half and the second half of the center section are each connected to a plurality of lifter housings, wherein each lifter housing is radially expandable.

3. The tire building drum of claim 2 wherein each lifter housing is connected to a linkage system.

4. The tire building drum of claim 3 wherein a sliding cylinder having a front face engages the linkage system and rotates a first linkage radially outward.

5. The tire building drum of claim 3 wherein the linkage system includes a first link having a first end pivotally connected to the lifter housing and a second end pivotally connected to the first end of a second link, wherein the second end of the second link is pivotally connected to a fixed point.

6. The tire building drum of claim 3 wherein a spring biases the lifter housing radially inward.

7. The tire building drum of claim 4 wherein the bead lock mechanism is mounted on the sliding cylinder.

8. The tire building drum of claim 7 wherein the bead lock mechanism has a radially inward roller positioned for engagement with a piston.

9. The tire building drum of claim 9 wherein the piston is slidably mounted in a chamber, wherein the chamber is mounted on the slidable cylinder.

10. The tire building drum of claim 1 wherein the center section does not have a center sleeve that extends the full width of the center section.

11. The tire building drum of claim 1 wherein a shoulder sleeve is located on each axially outer end of the center section, but does not extend over the center section.

12. A tire building drum comprising: a rotatable drum having a center section and a right and left section, wherein the right and left section are each located adjacent the center section, wherein the right and left sections each have a radially expandable bead lock mechanism mounted on a sliding cylinder, wherein the bead lock mechanisms are axially movable independent of each other, wherein the ends of the center section are each connected to a plurality of radially expandable lifter housings, wherein each lifter housing is connected to a linkage system, wherein each sliding cylinder has a front face positioned for engagement with the linkage system, wherein actuation of the sliding cylinder causes the lifter system to radially expand and the radial expansion of the center section.

13. The tire building drum of claim 12 wherein the linkage system includes a first link having a first end pivotally connected to the lifter housing and a second end pivotally connected to the first end of a second link, wherein the second end of the second link is pivotally connected to a fixed point.

14. The tire building drum of claim 12 wherein the sliding sleeve slides on a inner drum sleeve.

15. The tire building drum of claim 13 wherein the sliding sleeve engages the second link of the linkage system wherein the second link is rotated about the fixed point.
